(19) United States
(12) Patent Application Publication
(10) Pub. No.: US 2010/0054128 A1
(43) Pub. Date: Mar. 4, 2010

(54) Near Real-Time Alerting of IP Traffic Flow to Subscribers

(76) Inventor: William O'Hern, Spring Lake, NJ (US)

Correspondence Address: AT&T Legal Department - HBH;Attn: Patent Docketing, One AT&T Way, Room 2A-207, Bedminster, NJ, 07921, US

(21) Appl. No.: 12/201,288

(22) Filed: Aug. 29, 2008

(51) Int. Cl. H04L 1/24

(52) U.S. Cl. 370/235

(57) ABSTRACT

Methods, systems, and computer-readable media for providing near real-time alerts to users of IP traffic flow patterns on an IP network are provided. IP flow data collected from the network is periodically analyzed to determine if alerts need to be generated, based on a number of alert filters received from users. If alerts are to be generated, they are generated for transmission to the associated users.

### BACKGROUND

This application relates generally to the field of Internet Protocol (IP) network traffic flow analysis. More specifically, the disclosure provided herein relates to the collection of IP flow data and generation of alerts.

Advertising on the Internet can be different from print, radio, and TV advertising, in that advertisers may not have accurate and reliable measures of ad effectiveness comparable to the reach and frequency measures available for more traditional advertising forms. For example, Web advertisers currently must rely on statistics from individual website owners to report the number of “hits” on their sites. This is an unreliable method and can be artificially inflated by the website owner “pinging” their own site or from botnet activity, i.e. a collection of autonomously running software programs, called “bots”.

Web advertisers often resort to the costly and inefficient practice of placing ads on a number of sites and letting them run for long periods of time in hopes of gaining adequate coverage. This is often necessary because the advertisers are not provided with services that allow them to understand where the “most viewed” and “hot” sites are on the Internet. In addition, website owners do not have a methodology for providing reliable, independent statistics regarding the traffic at their sites with which to sell ad space to advertisers.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter

Embodiments of the disclosure presented herein include methods, systems, and computer-readable media for providing near real-time alerts to users of IP traffic flow patterns on an IP network. According to one aspect, a method for alerting users of IP traffic flow patterns on an IP network is provided. IP flow data collected from the network is periodically analyzed to determine if alerts need to be generated based on a number of alert filters received from the users. If so, the alerts are generated for transmission to the associated users. In one aspect, the IP flow data includes a timestamp, a source address, a destination address, a protocol, and a packet count. In another aspect, the alert filters include a protocol, a metric, a frequency, and an email address.

According to another aspect, a system for alerting users of IP flow patterns is provided. An alerting service module periodically analyzes IP flow data collected from the network to determine, based on a number of alert filters received from the users, whether to generate alerts. If alerts are to be generated, they are generated according to the alert filters for transmission to the associated users. In one aspect, the alerts contain information in addition to the IP flow data, such as demographic information regarding associated destination addresses.

According to yet another aspect, a computer-readable medium having instructions stored thereon for execution by a processor to perform the method described above is provided. Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating an operating environment for alerting subscribers of IP traffic flow patterns, in accordance with exemplary embodiments.

FIGS. 2 and 3 are block diagrams providing further details of the operating environment, in accordance with exemplary embodiments.

FIG. 4 is a flow diagram illustrating one method for alerting subscribers of IP traffic flow patterns, in accordance with exemplary embodiments.

FIG. 5 is a block diagram showing an illustrative computer hardware and software architecture for a computing system capable of implementing aspects of the embodiments presented herein.

### DETAILED DESCRIPTION

The following detailed description is directed to methods, systems, and computer-readable media for alerting subscribers and users of subscriber devices of IP traffic flow patterns. Utilizing the technologies described herein, subscribers may be alerted to specific IP flow patterns on an IP backbone or other IP network on a periodic basis of their choosing. Web advertisers may receive hourly, daily, or weekly reports of the current “hot” sites on the Internet and use the information to make near real-time decisions on where to place their Web-based advertisements. In addition, website owners can get reports with reliable, independent statistics regarding traffic at their site and provide the reports to potential advertisers as part of their advertising package information.

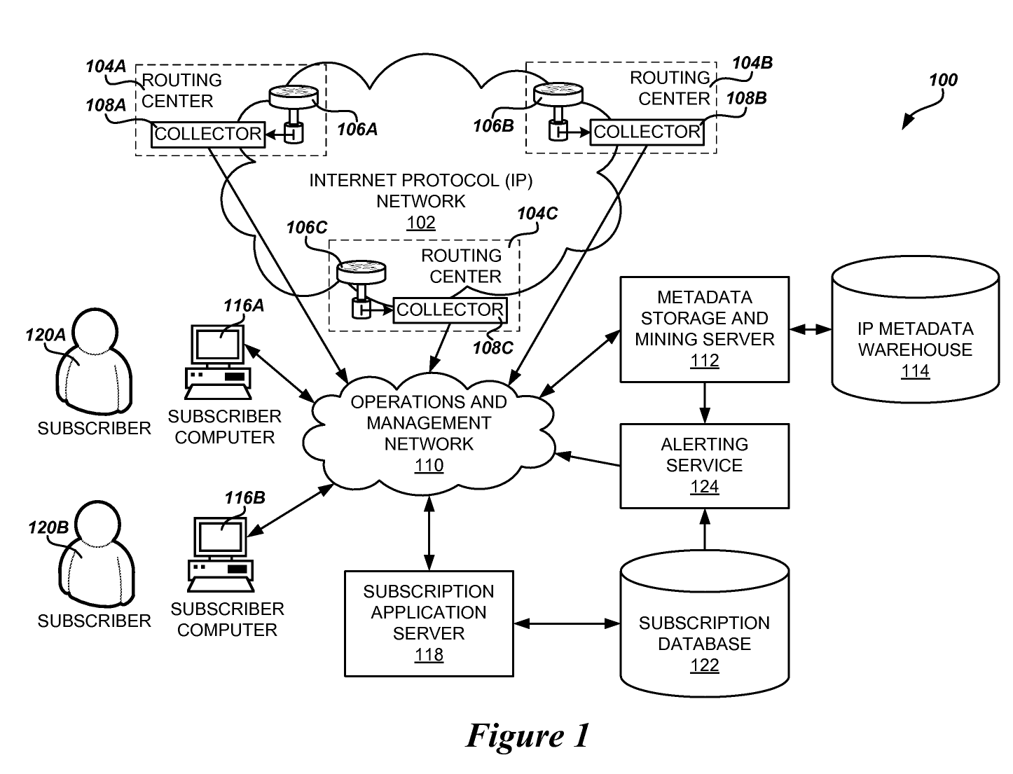

In the following detailed description, references are made to the accompanying drawings that form a part hereof, and that show by way of illustration specific embodiments or examples. In referring to the drawings, it is to be understood that like numerals represent like elements through the several figures, and that not all components described and illustrated with reference to the figures are required for all embodiments. Referring now to FIG. 1, an illustrative operating environment 100 and several software components for alerting subscribers of IP traffic flow patterns is shown, according to embodiments. The environment 100 includes an Internet Protocol (IP) network 102. According to one embodiment, the IP network 102 is an Internet backbone network, such as that provided by a network service provider (NSP), upon which flows a variety of Internet traffic, including, but not limited to, Web browsing, email, instant messaging (IM), file sharing, telephone calls (VoIP), television (IPTV), and streaming media. It will be appreciated, however, that the IP network 102 may represent any network containing IP traffic.

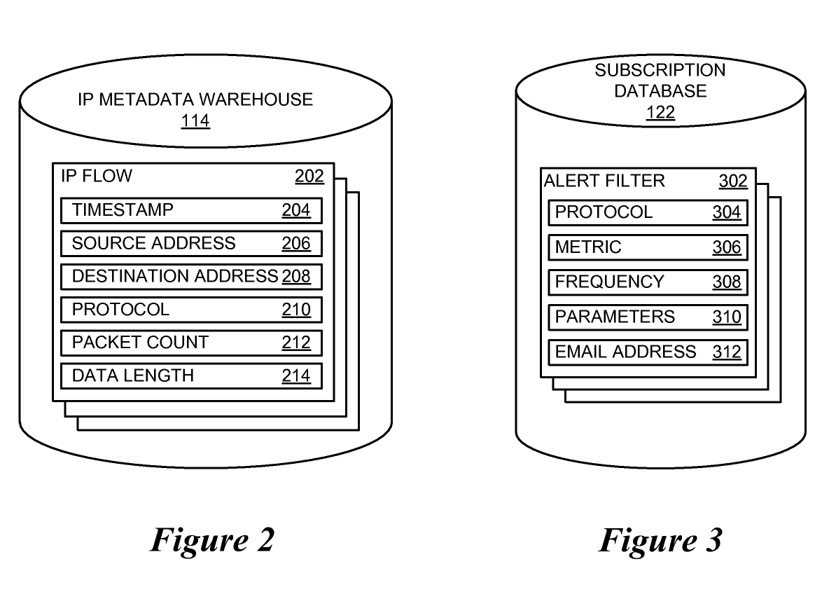

The topology of the IP network (102) includes a number of network segments connected by routing centers 104A-104C. According to embodiments, the majority of IP network traffic flows through at least one of these routing centers 104A-104C as the IP network traffic travels from a source computer to a destination computer. Located in each of the routing centers 104A-104C is an optical splitter 106A-106C or an equivalent device which allows the IP traffic flowing through the routing centers 104A-104C to be accessed and IP metadata to be collected. IP metadata includes information extracted from the header of individual IP packets regarding the transmission and routing of the packets through the network 102, including, but not limited to, source address, destination address, protocol, and packet size. The IP metadata may further include information extracted from the data portion of the IP packet depending on the protocol used, as will be discussed in more detail below in regard to FIG. 2.

The IP metadata is collected from the optical splitters 106A-106C by collectors 108A-108C located in each routing center 104A-104C, according to exemplary embodiments. The collectors 108A-108C collect the IP metadata and send the data across an operations and management network 110 to a metadata storage and mining server 112. The operations and management network 110 may be the same network as the IP network 102 or it may be a separate, isolated network for internal communication within the NSP. The metadata storage and mining server 112 may be any server computer or device which allows the IP metadata to be stored and later queried, sorted, and analyzed by the various components described herein. In one embodiment, the metadata storage and mining server 112 is a database server.

According to one embodiment, the IP metadata is aggregated by the collectors 108A-108C before being sent to the metadata storage and mining server 112 for storage. For example, all the IP packets between the same source and destination computers utilizing the same protocol within an identified “conversation” or over a pre-determined period time may be aggregated together as a single “net-flow” or IP flow. The IP flow data includes the IP metadata from the IP packets associated with the IP flow, along with a total count of the IP packets and a cumulative data size of the IP flow. In another embodiment, the aggregation is performed by the metadata storage and mining server 112.

According to exemplary embodiments, the metadata storage and mining server 112 stores the IP metadata in an IP metadata warehouse 114. The IP metadata warehouse 114 may be any storage mechanism that allows the metadata storage and mining server 112 to store and later retrieve the IP metadata, including, but not limited to, database tables, flat files, and in-memory data structures. As illustrated in FIG. 2, the aggregated IP metadata may be stored in the IP metadata warehouse 114 as a single IP flow record 202, representing the IP flow. The IP flow record 202 may include a timestamp 204 indicating when the IP flow occurred, a source address 206 identifying the sending computer, a destination address 208 identifying the receiving computer, a protocol 210 indicating the protocol of communication used between them, a packet count 212 indicating the number of packets transmitted in the IP flow, and a data length 214 indicating the total amount of data transmitted in the IP flow.

As will be appreciated by one skilled in the art, the protocol 210 may indicate any transport layer protocol carried on the IP network, including, but not limited to, Transmission Control Protocol (TCP), User Datagram Protocol (UDP), and Internet Control Message Protocol (ICMP). Further protocol information may be determined by extracting additional information from the IP packet header or data. For example, for TCP and UDP packets, the source and/or destination port numbers may be extracted to determine the application layer protocol being used in the IP flow. Application layer protocols that may be determined include, but are not limited to, Hypertext Transfer Protocol (HTTP) used for access to Web pages, Simple Mail Transfer Protocol (SMTP) for sending email, File Transfer Protocol (FTP) for downloading files, BitTorrent for peer-to-peer file sharing, and Real-time Transport Protocol (RTP) or Real-time Transport Streaming Protocol (RTSP) used to stream video and other media. According to embodiments described herein, the protocol 210 stored in the IP flow record 202 indicates both the transport layer and application layer protocols utilized in the IP flow. It will be further appreciated that any number of data items could be extracted from the IP packet header and data and included in the IP flow record 202 stored in the IP metadata warehouse 114 to indicate the characteristics of individual IP flows.

The environment 100 also includes a number of subscriber computers 116A-116B connected to a subscription application server 118 that allows subscribers 120A-120B and other authorized users of the subscriber computers 116A-116B to specify IP traffic patterns on the IP network 102 for which they wish to be alerted, according to embodiments provided herein. The subscriber computers 116A-116B are connected to the subscription application server 118 through a network, such as the IP network 102, the operations and management network 110, or a combination thereof. The subscription application server 118 may be a web application server accessed by web browser applications executing on the subscriber computers 116A-116B.

The subscription application server 118 may further be connected to a subscription database 122 in which subscription information is maintained for each subscriber 120A-120B. The subscription information includes data identifying the subscriber 120A-120B as well as one or more alert filters 302, as illustrated in FIG. 3. An alert filter 302 specifies an individual IP traffic pattern on the IP network 102 for which the subscriber 120A-120B wishes to be alerted. The alert filter 302 includes a protocol 304 and a metric 306 which together identify the IP traffic pattern of interest. For example, a subscriber, such as the subscriber 120A, may be a Web advertiser who wants to be alerted on a daily basis of the Web sites on the IP network having the highest number of unique visitors. The subscriber 120A may utilize the subscriber computer 116A and the subscription application server 118 to create an alert filter, such as the alert filter 302, with a protocol, such as the protocol 304, specifying HTTP and a metric, such as the metric 306, specifying the destination addresses with the largest number of IP flows with unique source addresses in the given period of time. In addition, the alert filter 302 in this case would include a frequency 308 specifying that the subscriber 120A should be alerted daily of the desired metric 306 and protocol 304.

In another example, a subscriber or authorized user, such as the subscriber 120B, may be interested in being alerted of the sites streaming the most video traffic every hour. The subscriber 120B in this case may create an alert filter, such as the alert filter 302, with a protocol, such as the protocol 304, specifying RTSP and a metric, such as the metric 306, specifying the source addresses with the maximum number of IP flows per hour. The frequency 308 could be set such that the subscriber 120B is alerted each hour. According to one embodiment, additional parameters 310 may be specified for the alert filter 302 in order to accommodate request for alerts with metrics corresponding to a particular destination or source address or alerts that are generated when a metric exceeds some threshold value. It will be appreciated that any number of combinations of the protocol 304, metric 306, frequency 308, and additional parameters 310 for the alert filters 302 may be imagined by one skilled in the art, and it is the intent of this application to include all such combinations. In further embodiments, each alert filter 302 in the subscription database 122 also includes an email address 312 or some other unique identifier of the subscriber 120A-120B that is to be provided with the associated alert.

An alerting service 124 is included in the environment 100 that periodically analyzes the IP metadata contained in the IP metadata warehouse 114 to determine if alerts should be generated to the subscribers 120A-120B of specific IP traffic flow patterns based on their associated alert filters 302. According to an exemplary embodiment, the alerting service 124 is a software module that may execute on the subscription application server 118, the metadata storage and mining server 112, or some other server platform within the operating environment 100. The alerting service 124 may access the IP metadata warehouse 114 through the metadata storage and mining server 112 or directly to query the IP metadata. The alerting service 124 also accesses the alert filters 302 in the subscription database 122 to determine which alerts should be generated, as will be discussed in more detail below.

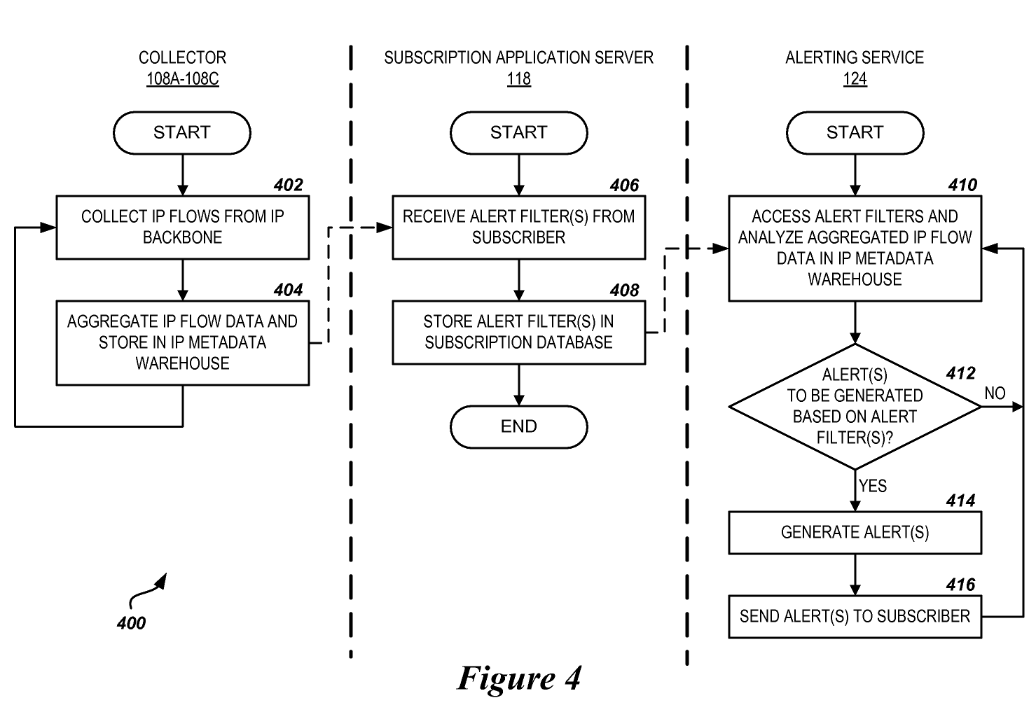

Referring now to FIG. 4, additional aspects regarding the operation of the components and software modules described above in regard to FIG. 1 will be provided. In particular, FIG. 4 illustrates an exemplary routine 400 for alerting individual subscribers of IP traffic flow patterns according to the requirements specified in the subscriber's alert filters 302, in accordance with exemplary embodiments. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof.

It should also be appreciated that, while the operations are depicted in FIG. 4 as occurring in a sequence, various operations described herein may be performed by different components or modules at different times. In addition, more or fewer operations may be performed than shown, and the operations may be performed in a different order than illustrated in FIG. 4.

The routine 400 begins at operation 402, where the collectors 108A-108C collect the IP metadata from the IP network 102. Each collector 108A-108C collects data flowing through its related routing center 104A-104C. In one embodiment, the collectors 108A-108C are configured such that duplicate IP metadata is not collected at multiple routing centers 104A-104C on the network 102. The routine 400 proceeds from operation 402 to operation 404, where the IP metadata is aggregated into IP flows. The IP metadata may be aggregated into IP flows by the collectors 108A-108C or the metadata storage and mining server 112, as described above in regard to FIG. 1. The IP flow data is then stored in the IP metadata warehouse 1 14. Note that the collectors 108A-108C may continuously perform the operations of collecting and aggregating IP flow data from the IP network 102 and store it in the IP metadata warehouse 114, as indicated by the flow line from operation 404 returning to operation 402 in FIG. 4.

At operation 406 in the routine 400, the subscription application server 118 receives one or more alert filters from a subscriber 120A-120B. As discussed above, the subscription application server 118 may be a web application server which allows the subscribers 120A-120B to utilize Web browser applications executing on the subscriber computers 116A-116B to specify the details of each alert filter 302. The subscription application server 118 then stores the specified alert filters 302 in the subscription database 122 at operation 408. From operation 408, the process performed by the subscription application server 118 ends.

At operation 410 in the routine 400, the alerting service 124 periodically accesses the alert filters 302 in the subscription database 122 and analyzes the IP flow data in the IP metadata warehouse 114 to determine whether alerts are to be generated to the subscribers 120A-120B. This periodic operation may be performed hourly or every minute, depending on the lowest level of frequency which may be specified in the alert filter 302 and other performance-related issues. In one embodiment, the alerting service 124 will check the frequency 308 of each active alert filter 302 and other subscription data to determine if an alert to the associated subscriber 120A-120B is due. In another embodiment, the generation of alerts may be based on the occurrence of certain IP flow patterns in the IP flow data that correspond to the protocol 304, metric 306, and additional parameters 310 of the alert filter 302.

If, at operation 412, the alerting service 124 determines that no alerts are to be generated, the routine 400 returns to operation 410 where the alerting service 124 performs the next periodic check of the alert filters 302 and the IP flow data. If, however, the alerting service 124 determines that alerts are to be generated based on the alert filters 302 in the subscription database 122 and the IP flow data in the IP metadata warehouse 114, the routine 400 proceeds to operation 414, where the alerting service 124 generates the alerts. The type and content of the alert may depend on the protocol 304, metric 306, and additional parameters 310 specified in the alert filter 302.

Continuing the example provided above in regard to FIG. 3, the alert filter 302 may specify a protocol, such as the protocol 304, of HTTP, a metric, such as the metric 306, representing destination addresses having the largest number of IP flows with unique source addresses, and a frequency, such as the frequency 308, of daily in order to create a list of the top ten Web sites on the IP network 102 on a daily basis. The alerting service 124 may use the metadata storage and mining server 112 to query the IP metadata warehouse 114 and count the IP flow records 202 from unique source addresses 206 for each destination address 208 having the protocol 210 of HTTP and having a timestamp, such as the timestamp 204, within the last 24 hours. Because the complete IP metadata for each IP flow to the destination address 208 is available, the metadata storage and mining server 112 may filter out of the count IP flows that potentially represent botnet activity or some other automated activity designed to inflate the traffic for a website. The metadata storage and mining server 112 will then sort the destination addresses 208 in descending order of IP flow count and return the top ten to the alerting service 124 from which to format the alert.

In one embodiment, the alerting service 124 may have access to additional information regarding each destination address returned by the metadata storage and mining server 112. For example, website owners may provide advertising opportunities, ad rates, demographic data about viewers, and other information regarding websites corresponding to one or more of the destination addresses 208 in the alert. This additional information may be supplied by the website owners in order to attract potential advertisers to their site. When additional information is available, the alerting service 124 will add the information to the corresponding alerts, according to exemplary embodiments.

From operation 414, the routine 400 proceeds to operation 416, where the alerting service 124 sends the alerts to the subscribers 120A-120B associated with the alert filters 302. According to one embodiment, each alert filter 302 includes an email address, such as the 312. The alerting service 124 may use this email address 312 to email a formatted alert to the associated subscriber 120A-120B for each alert generated. It will be appreciated that any number of methods may be utilized for alerting a subscriber, including, but not limited to, email, text message, instant message (IM), Really Simple Syndication (RSS) feed, or online alert. From operation 416, the routine 400 returns to operation 410 where the alerting service 124 performs the next periodic check of the alert filters 302 and the IP flow data.

In a further embodiment, the subscription application server 118 provides services to the subscribers 120A-120B allowing them to view specific metrics and protocols in real-time, bypassing the requirement of creating the alert filter 302 and waiting for the generation of a corresponding alert. The subscription application server 118 may use the metadata storage and mining server 112 to query the IP metadata warehouse 114 and return the specified information. For example, a subscriber, such as the subscriber 120A, may use the subscriber computer 116A to request a list of the top ten websites over the last hour. The metadata storage and mining server 112 will query the IP metadata warehouse 114 to count the IP flow records 202 from unique source addresses 206 for each destination address 208 having a protocol, such as the protocol 210, of HTTP and having a timestamp, such as the timestamp 204, within the last hour. The metadata storage and mining server 112 will then sort the destination addresses 208 in descending order of IP flow count and return the top ten to the subscription application server 118, which will display the top ten destination addresses to the subscriber 120A on the subscriber computer 116A.

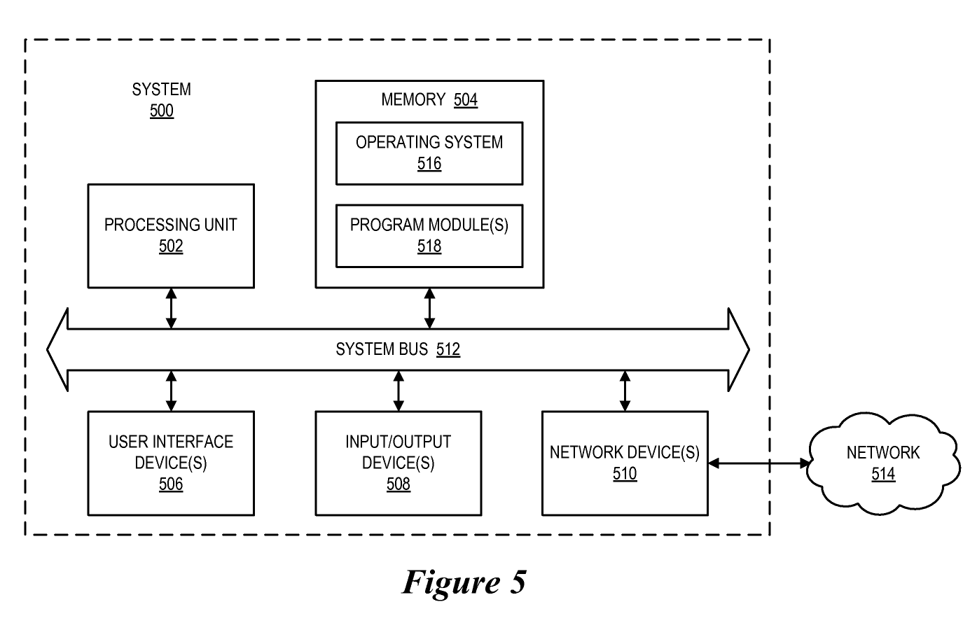

FIG. 5 is a block diagram illustrating a computer system 500 configured to alert subscribers of IP traffic flow patterns, in accordance with exemplary embodiments. Examples of the computer system 500 may include the metadata storage and mining server 112, the subscription application server 118, and the advertiser computers 116A-116B. The computer system 500 includes a processing unit 502, a memory 504, one or more user interface devices 506, one or more input/output (“I/O”) devices 508, and one or more network devices 510, each of which is operatively connected to a system bus 512. The bus 512 enables bidirectional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the computer. Processing units are well-known in the art, and therefore not described in further detail herein.

The memory 504 communicates with the processing unit 502 via the system bus 512. In one embodiment, the memory 504 is operatively connected to a memory controller (not shown) that enables communication with the processing unit 502 via the system bus 512. The memory 504 includes an operating system 516 and one or more program modules 518, according to exemplary embodiments. Examples of operating systems, such as the operating system 516, include, but are not limited to, WINDOWS®, WINDOWS® CE, and WINDOWS MOBILE® from MICROSOFT CORPORATION, LINUX, SYMBIAN™ from SYMBIAN SOFTWARE LTD., BREW® from QUALCOMM INCORPORATED, MAC OS® from APPLE INC., and FREEBSD operating system. Examples of the program modules 518 include the collector module 108A-108C, the metadata storage and mining server 112 module, the alerting service 124, and the subscription application server 118 module. In one embodiment, the program modules 518 are embodied in computer-readable media containing instructions that, when executed by the processing unit 502, performs the routine 400 for alerting subscribers of IP traffic flow patterns, as described in greater detail above with respect to FIG. 4. According to further embodiments, the program modules 518 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 518. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via a network 514. Examples of the network 514 may include, but are not limited to, the IP network 102 and the operations and management network 110. Examples of the network devices 510 may include, but are not limited to, a modem, a radio frequency (“RF”) or infrared (“IR”) transceiver, a telephonic interface, a bridge, a router, or a network card. The network 514 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 514 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for alerting users of Internet Protocol (IP) flow patterns, comprising:
analyzing IP flow data collected from an IP network to determine, based on one or more alert filters received from a user, whether to generate an alert; and
upon determining an alert is to be generated, generating the alert for transmission to the user.

2. The method of claim 1 further comprising:
collecting IP metadata from an Internet backbone network;
aggregating the IP metadata into IP flow data;
storing the IP flow data;
receiving one or more alert filters from a user; and
storing the one or more alert filters.

3. The method of claim 1, wherein the IP flow data comprises a plurality of IP flows.

4. The method of claim 3, wherein each of the plurality of IP flows comprises a timestamp, a source address, a destination address, and a protocol.

5. The method of claim 4, wherein each of the plurality of IP flows further comprises a packet count.

6. The method of claim 1, wherein each of the one or more alert filters comprises a protocol and a metric.

7. The method of claim 6 wherein the protocol comprises Hyper-text Transport Protocol (HTTP) and the metric comprises a destination address having a highest number of accesses by unique source address over a period of time.

8. A system for alerting users of Internet Protocol (IP) flow patterns, comprising:
an input for receiving collected IP flow data from an IP network and one or more alert filters from a user; and
an alerting service module operative to analyze the IP flow data to determine, based on the one or more alert filters, whether to generate an alert, and upon determining an alert is to be generated, generate the alert for transmission to the user.

9. The system of claim 8, wherein the IP flow data comprises a plurality of IP flows.

10. The system of claim 9, wherein each of the plurality of IP flows comprises a timestamp, a source address, a destination address, and a protocol.

11. The system of claim 8, wherein each of the one or more alert filters comprises a protocol and a metric.

12. The system of claim 11, wherein the protocol comprises Hyper-text Transport Protocol (HTTP) and the metric comprises a destination address having a highest number of accesses by unique source address over a period of time.

13. The system of claim 12, wherein the alert includes demographic data associated with the destination address.

14. A computer readable storage medium having computer executable instructions stored thereon that, when executed by a computer, cause the computer to:
analyze IP flow data collected from an IP network to determine, based on one or more alert filters received from a user, whether to generate an alert; and
upon determining an alert is to be generated, generate the alert for transmission to the user.

15. The computer readable storage medium of claim 14, wherein the IP flow data comprises a plurality of IP flows.

16. The computer readable storage medium of claim 15, wherein each of the plurality of IP flows comprises a timestamp, a source address, a destination address, and a protocol.

17. The computer readable storage medium of claim 16, wherein each of the plurality of IP flows further comprises a packet count.

18. The computer readable storage medium of claim 14, wherein each of the one or more alert filters comprises a protocol and a metric.

19. The computer readable storage medium of claim 18, wherein the protocol comprises Hyper-text Transport Protocol (HTTP) and the metric comprises a destination address having a highest number of accesses by unique source address over a period of time.

20. The computer readable storage medium of claim 19, wherein the alert includes demographic data associated with the destination address.
